(19) United States
(12) Patent Application Publication
(10) Pub. No.: US 2026/0008197 A1
(43) Pub. Date: Jan. 8, 2026

(54) PILL CUTTING APPARATUS

(71) Applicant: Jinwoo KIM, Donghae-si (KR)

(72) Inventor: Jinwoo KIM, Donghae-si (KR)

(21) Appl. No.: 19/261,914

(22) Filed: Jul. 7, 2025

(30) Foreign Application Priority Data
Jul. 5, 2024 (KR) 10-2024-0089023

(51) Int. Cl. B26D 1/08; A61J 7/00; B26D 7/02

(52) U.S. Cl. CPC B26D 1/08; B26D 7/02; A61J 7/0007

(57) ABSTRACT

An alignment cutting device includes: a main body; an alignment unit which is movably coupled to the main body and grips an object from both sides of the object and aligns the object; a cutting unit which is movably coupled to the main body and having a cutting blade for cutting the object; a linkage movement induction unit which moves the alignment unit in response to movement of the cutting unit to align the object below the cutting blade; an inclined guide coupled to the alignment unit; and an inclined guide corresponding unit coupled to the linkage movement induction unit.

### CROSS REFERENCE TO RELATED APPLICATIONS

This application claims priority to Korean Application No. 10-2024-0089023 filed on Jul. 5, 2024, the entire content of which is herein incorporated by reference in its entirety.

### TECHNICAL FIELD

The present invention relates to an alignment cutting device for conveniently aligning and accurately cutting an object such as pills, sugar cubes, solid salt, solid detergent, etc.

### TECHNICAL BACKGROUND

Unless otherwise indicated herein, the matters described in this section are not prior art of the present invention and do not constitute admission that they are prior art.

Dosage of medication prescribed or administered varies depending on patient's age or severity of symptoms. So, there are cases where the tablet must be cut to meet a dosage required.

However, there is no dedicated cutting device for cutting pills in hospitals, pharmacies, or at home. Thus, most people cut them by hand or use scissors or a knife.

There are commercially available tablets that have linear cutting guide grooves which are formed in advance during a manufacturing process to allow easier cutting of tablets. However, it is still difficult to hold and cut the tablet by hand depending on the size or shape of the tablet. Furthermore, the tablet often is cut at an unwanted location, rather than the location intended.

Not only pills but also solid substances such as sugar cubes, solid salt, and solid detergents are also often needed to be cut into appropriate sizes.

For example, Korean Patent Publication No. 10-2010-0106900 (published on Oct. 4, 2010) discloses a conventional aligning cutting device for aligning and cutting objects such as pills, sugar cubes, solid salt, and solid detergents. Specifically, the pill cutting device includes: a pair of handles; a pair of cutting blades mounted on a front end of the handles; and a support member integrally formed with the pair of handles and the pair of cutting blades rotating about a hinge shaft (4) formed of screws or rivets, wherein the support member includes a fixing groove (51) inserted into a front end of a cutting blade positioned at a lower side among the pair of cutting blades; a horizontal plate having a V-shaped cut-out hole formed at both sides thereof with respect to a through-hole, wherein the through-hole is horizontally formed at an upper side of the fixing groove and allowing the lower cutting blade to protrude and retract, wherein an inner side of the horizontal plate is a variable portion, wherein an outer side of the horizontal plate is a support portion; a guide portion protruding vertically from a front end of the horizontal plate, extending along the cut-out hole, narrowing in a V-shape, and having a lower side cut-out such that a rear end thereof is variable to both sides; and a fixing portion extending from one side of the support portion.

In addition, Korean Utility Model Publication No. 20-2010-0001968 (published on Feb. 24, 2010) discloses a pill cutting device. Specifically, the pill cutting device includes: base; a slider installed on the base in a slidable manner; a pair of insertion ribs elastically and shakably installed an end of the slider; a rotable body rotatablely installed in the base; a cutting unit installed an end of the rotable body and equipped with a cutting blade.

However, the conventional alignment cutting devices as described above have a problem. Alignment and cutting processes are required to be performed sequentially and thus the cutting time to cut the object is relatively long. Specifically, the cutting object, such as a pill, is positioned between the “V”-shaped guide or the insertion ribs arranged in the “V” shape. Then, the cutting object is cut by pressing and rotating the cutting blade.

As mentioned above, according to the above-mentioned conventional alignment cutting device, the cutting object, such as a pill, is fixed between the “V”-shaped guide or the insertion ribs arranged in the “V” shape. Then, it is allowed for the cutting blade to cut the object. Under this structure, the object could be broken while being cut because the object is firmly fixed by the “V”-shaped guide or by the insertion ribs arranged in a “V” shape.

### Prior Art Documents

Korean Patent Publication No. 10-2014-0012338 (Published on Feb. 3, 2014)

Korean Utility Model Publication No. 20-2010-0001968 (Published on Feb. 24, 2010)

### DETAILED DESCRIPTION OF INVENTION

### Problems to be Solved

The present invention provides an alignment cutting device capable of simultaneously performing alignment and cutting of an object, such as pills, sugar cubes, solid salt, and solid detergents, thus saving the time required for cutting the object.

In addition, according to the present invention, when aligning the objects to be cut, alignment sub-units holding the object move farther from each other to the opposite sides while being elastically supported. Thus, a cutting blade can cut the object clearly, thus preventing the object from being broken while being cut.

It should be noted that the advantages of the present invention are not limited to what described above, but may include other advantages derived from the following description.

### Summary of Invention

An alignment cutting device according to an embodiment of the present invention includes: a main body; an alignment unit which is movably coupled to the main body and grips an object from both sides of the object and aligns the object; a cutting unit which is movably coupled to the main body and having a cutting blade for cutting the object; a linkage movement induction unit which moves the alignment unit in response to movement of the cutting unit to align the object below the cutting blade; an inclined guide coupled to the alignment unit; and an inclined guide corresponding unit coupled to the linkage movement induction unit. The inclined guide corresponding unit is connectable to the inclined guide.

The alignment cutting device further includes an elastic support unit. The alignment unit includes a left and a right the alignment sub-units. When the object is aligned by the alignment unit, the elastic support unit (i) elastically supports the left and the right alignment sub-units and (ii) moves the left and right alignment sub-units to get farther from each other.

The alignment unit includes a left and a right alignment sub-units facing each other. The left and the right alignment sub-units are coupled to a front of the main body and arranged in a side by side manner with each other. Each of the left and the right alignment sub-units is coupled with the horizontal movement guide to be linearly movable along the horizontal movement guide.

A first vertical movement guide is coupled with the main body. The cutting unit is coupled with the first vertical movement guide to be linearly movable along the first vertical movement guide. The cutting blade is replaceably connected to the cutting unit.

The inclined guide is an inclined hole or an inclined groove. The inclined guide corresponding unit is a protrusion which is insertable into the inclined guide. The inclined guide is a first inclined surface. The inclined guide corresponding unit is a protrusion or a second inclined surface which is connectable with the first inclined surface.

The linkage movement induction unit is coupled to the cutting unit to be movable linearly in a vertical direction. The elastic support unit is provided between the cutting unit and the linkage movement induction unit.

An alignment cutting device according to another embodiment of the present invention includes: a main body; a horizontal movement guide coupled to a lower portion of the main body; a first vertical linear movement guide coupled to an upper portion of the main body; an alignment unit coupled to the lower portion of the main body, wherein the alignment unit includes a left and a right alignment sub-units arranged in a symmetrical manner to each other, wherein a rear side of the alignment unit is connected to the horizontal movement guide of the main body in a horizontally movable manner along the horizontal movement guide; a left and a right inclined guides respectively provided on a front side of the left alignment sub-unit and on a front side of the right alignment sub-unit, wherein each of the left and the right inclined guides extends upwardly and inclines toward a center of the main body; a cutting unit coupled to an upper center of the main body, wherein a rear side of the cutting unit is connected to the first vertical linear movement guide in a vertically movable manner; a second vertical linear movement guide connected to a front side of the cutting unit; a cutting blade for cutting an object, wherein the cutting blade is coupled to a lower center of the cutting unit; an elastic unit provided between the main body and the cutting unit and elastically biases the cutting unit upward; a linkage movement induction unit connected to the second vertical linear movement guide of the cutting unit in a linearly movable manner in a vertical direction; an inclined guide corresponding unit, wherein the inclined guide corresponding unit includes a left and a right inclined guide corresponding units connected to a lower portion of the linkage movement induction unit, wherein the left and the right inclined guide corresponding units repectively are coupled to the left and the right inclined guides, wherein the linkage movement induction unit moves the left and the right alignment sub-units to get closer to each other in a symmetrical manner to each other and aligns the object when the cutting unit moves downward; and an elastic support unit provided between the cutting unit and the linkage movement induction unit, wherein the elastic support unit elastically biases the linkage movement induction unit downward to make the object elastically supported by the alignment unit. The horizontal movement guide is a horizontal guide rod which is provided in the lower portion of the main body and extends horizontally. The rear side of the alignment unit is penetrated by the horizontal movement guide.

The horizontal movement guide is provided in the lower portion of the main body and extends horizontally. A channel-type slide is provided on the rear side of the alignment unit and is movably coupled to the horizontal movement guide.

The first vertical linear movement guide includes a left and a right first vertical guide rods. The left and the right first vertical guide rods are coupled to the upper portion of the main body and extend vertically as being spaced apart from each other. The rear side of the cutting unit is penetrated by the first vertical linear movement guide. The elastic unit is a coil spring surrounding the first vertical linear movement guide.

The first vertical linear movement guide is a guide rail, wherein the guide rail is provided in the upper center of the main body and extends vertically. A channel-shaped slide is coupled to the rear side of the cutting unit. The channel-shaped slide is coupled to the first vertical linear movement guide in a movable manner. The elastic unit includes a left and a right coil springs. The left and the right coil springs are provided through a top of the main body and extend vertically as being spaced apart from each other.

A left and a right gripping plates are integrally coupled to or replaceably coupled to a lower front side of the left alignment sub-unit and a lower front side of the right alignment sub-unit, respectively.

The cutting blade is replaceably connected to a lower center portion of the front side of the cutting unit.

The second vertical linear movement guide includes a left and a right second vertical guide rods. The left and the right second vertical guide rods are coupled to a front side of the main body and extend vertically as being spaced apart from each other. The linkage movement induction unit is penetratingly connected to the second vertical linear movement guide. The elastic support unit is a coil spring surrounding the second vertical linear movement guide.

Each of the left and the right inclined guides is an inclined hole or an inclined groove. The left and the right inclined guide corresponding units are protrusions which are insertable into the left and the right inclined guides, respectively.

Each of the left and the right inclined guides is a first inclined surface. Each of the left and the right inclined guide corresponding units is a protrusion or a second inclined surface connectable to the first inclined guide.

### Advantages of Invention

According to an alignment cutting device according to an embodiment of the present invention, when the cutting unit moves downwards, at the same time, the alignment sub-units symmetrically move inwards toward each other, e.g., toward the center of the cutting unit, upon movement of the cutting unit so that the object is aligned between the alignment units and cut by the cutting unit at the same time. Under this structure, the object, such as a pill, a sugar cube, solid salt, or solid detergent, can be conveniently and accurately cut. Also, the time required for cutting the object can be shortened.

According to an alignment cutting device according to an embodiment of the present invention, the object is held by and aligned by the alignment unit, and then the alignment sub- units moves outwards from each other while being elastically supported to provide a room for the cutting blade to clearly cut the object without breaking the object. Under this structure, due to the room, the cutting blade can pass through the object and thereby cut the object without breaking the object.

The advantages of the present invention are not limited to the effects mentioned above, and other effects not mentioned may be obtained.

### BRIEF DESCRIPTION OF DRAWINGS

FIG. 1 is a perspective view of an alignment cutting device according to an embodiment of the present invention.

FIG. 2 is an exploded perspective view of an alignment cutting device according to an embodiment of the present invention.

FIG. 3 shows an alignment operation of an alignment cutting device according to an embodiment of the present invention.

FIG. 4 shows a cutting operation of an alignment cutting device according to an embodiment of the present invention.

FIG. 5 is a perspective view of an alignment cutting device according to another embodiment of the present invention.

FIG. 6 is an exploded perspective view of an alignment cutting device according to another embodiment of the present invention.

FIG. 7 shows an alignment operation of an alignment cutting device according to another embodiment of the disclosed content.

FIG. 8 shows a cutting operation of an alignment cutting device according to another embodiment of the present invention.

FIG. 9 is a perspective view of an alignment cutting device according to yet another embodiment of the present invention, wherein an alignment unit has an inclined guide, wherein the inclined guide is an inclined surface.

### EMBODIMENTS

Hereinafter, the configuration and operational effects of a preferred embodiment will be examined with reference to the attached drawings.

For reference, in the accompanied drawings, some components are omitted or schematically illustrated for convenience and clarity of understanding. The size of each component does not reflect the actual size.

Additionally, throughout the specification, the same reference numerals refer to the same components. In drawings, reference numerals for the same components may be shown in some figures, but may be omitted in other figures.

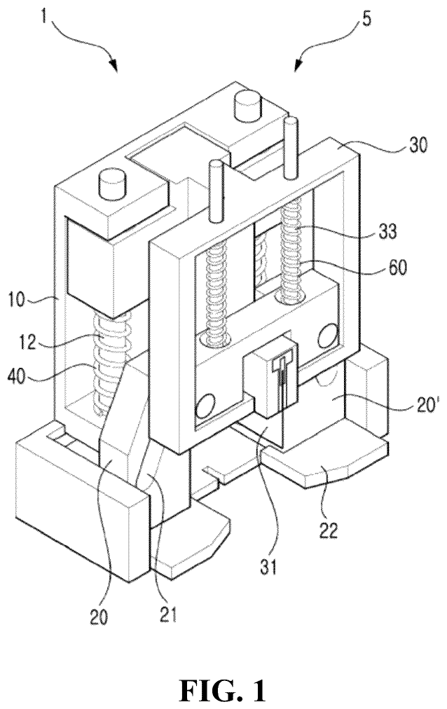

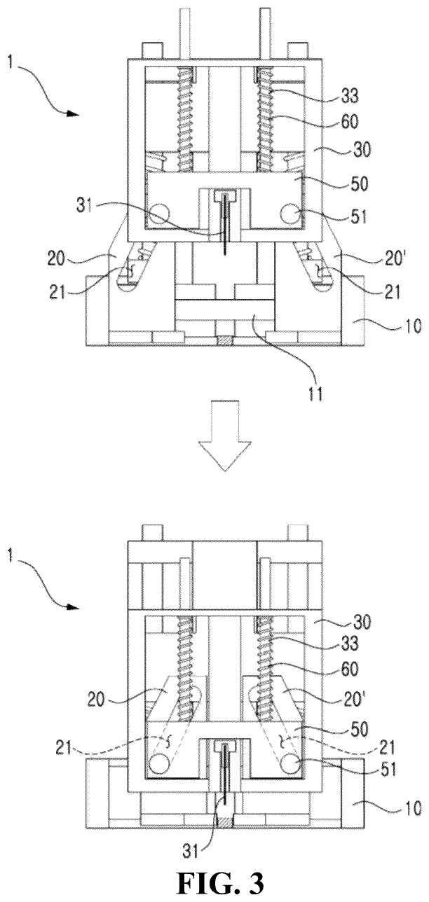

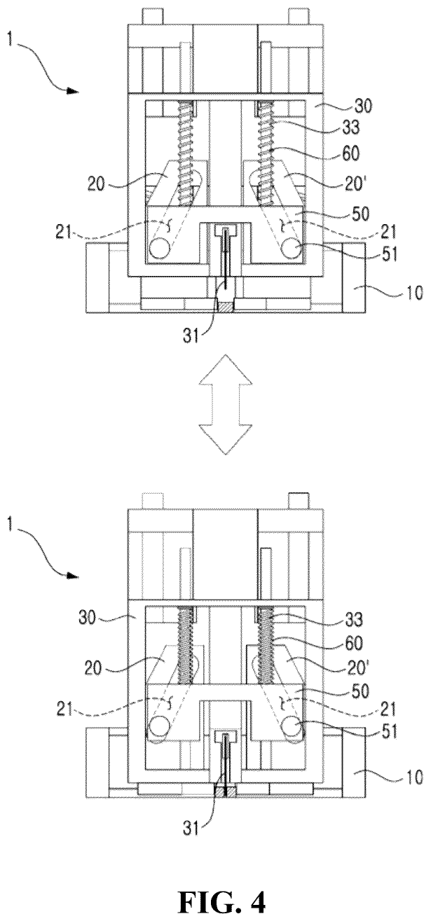

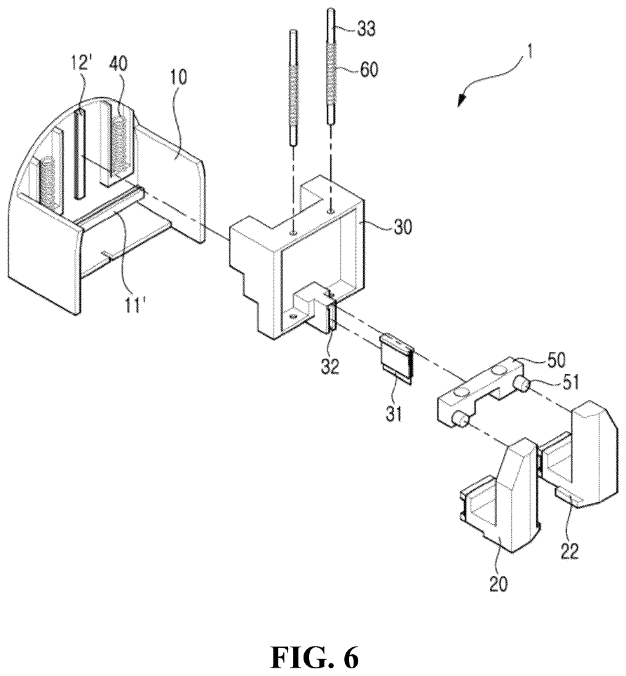

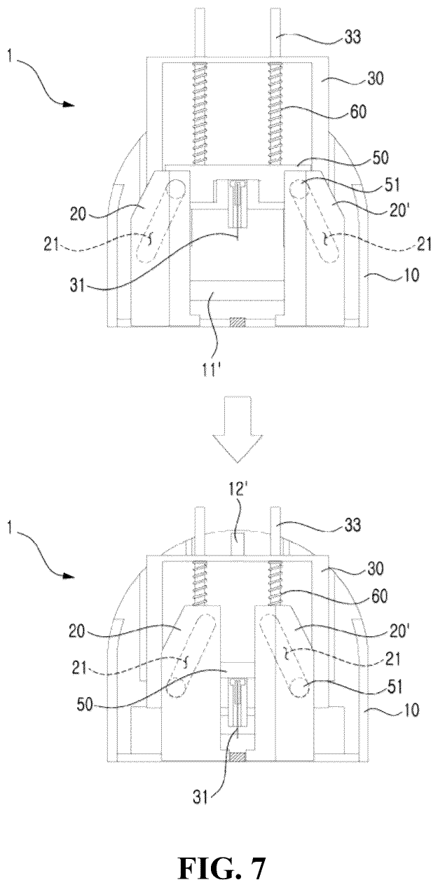

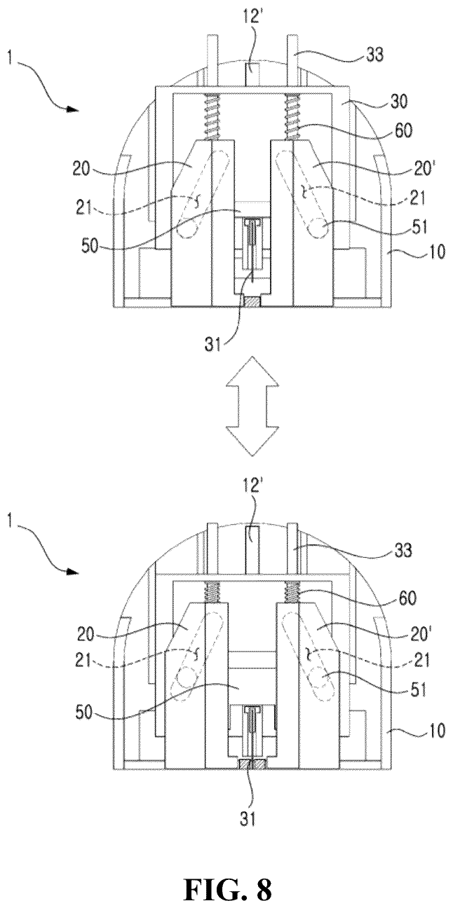

Referring to FIGS. 1-9, an alignment cutting device according to an embodiment of the present invention includes: a main body (10); an alignment unit (20) that is movably installed on the main body (10), and grips an object from both sides of the object to align the object; a cutting unit (30) movably installed in the main body (10) and equipped with a cutting blade for cutting the object to be cut; and a linkage movement induction unit (50) that moves the alignment unit (20) in conjunction with movement of the cutting unit (30), and aligns the object directly below the cutting blade. The alignment cutting device may further include an elastic support unit which (i) elastically supports the alignment unit and (ii) moves the alignment unit to opposite sides to each other when the alignment unit grips the object.

Here, according to a preferred embodiment of the present invention, the main body (10) serves to form a support frame of the alignment cutting device (1) and at the same time serves to form a guide frame for guiding linear horizontal movement of the alignment unit (20) in a left-right direction and linear vertical movement of the cutting unit (30) in an up-down direction.

A horizontal movement guide (11, 11′) is coupled to a lower portion of the main body (10). An alignment unit (20) is connected to the horizontal movement guide (11, 11′)
in a linearly movable in a left-right direction, i.e., in a horizontal direction.

In an embodiment, the horizontal movement guide (11, 11′) is a horizontal guide rod (11) that extends horizontally from the lower portion of the main body (10) as shown in FIGS. 1 to 4. The rear side of the alignment unit (20) is connected to the horizontal movement guide (11) so that the alignment unit (20) can move linearly in the left-right direction. A ball bushing may be provided in the rear side of the alignment unit (20) to be coupled to the horizontal movement guide (11, 11′), i.e., the horizontal guide rod (11).

In another embodiment, the rear side of the horizontal movement guide (11) and the alignment unit (20) can be formed with the reverse structure.

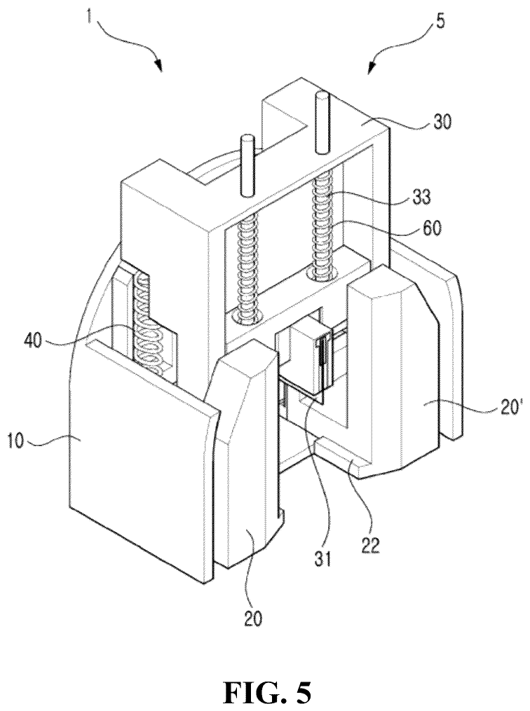

In another embodiment, the horizontal movement guide (11, 11′) may be a guide rail (11′) which provided at the lower portion of the main body (10) and extends horizontally as shown in FIGS. 5 to 8. A channel-type slide (LM guide), which is slidably connected to the horizontal movement guide (11′), can be connected to the rear side of the alignment unit (20).

In another embodiment, the rear side of the horizontal movement guide (11′) and the alignment unit (20) can be formed with the reverse structure.

The upper portion of the main body (10) is provided with a first vertical linear movement guide (12, 12′). A cutting unit (30) is connected to the first vertical linear movement guide (12, 12′) capable of moving linearly in the up-down direction.

As shown in FIGS. 1-4, the first vertical linear movement guide (12) may provided over an upper portion of the main body (10) and include a left and a right vertical linear movement guide (12). The left and the right vertical linear movement guide (12) extend vertically as being spaced apart from each other.

The rear side of the cutting unit (30) is penetrated by the first vertical linear movement guide (12) so that the cutting unit (30) moves linearly in the up-down direction along the first vertical linear movement guide (12). In case where the first vertical linear movement guide (12) is a first vertical guide rod, a ball bushing may be provided on the rear side of the cutting unit (30) in such a manner as corresponding to the first vertical guide rod.

Alternatively, the rear side of the first vertical linear movement guide (12) and the cutting unit (30) can be formed with the reverse structure.

In another embodiment, as shown in FIGS. 5-8, the first vertical linear movement guide (12′) is a guide rail. The guide rail (12′) is coupled to the upper center of the main body (10) and extends vertically.

A channel-type slide (LM guide) is connected to the rear side of the cutting unit (30), and connected to the first vertical linear movement guide (12′), i.e., the guide rail (12′) to be capable of sliding along the guide rail (12′). Alternatively, the rear side of the first vertical linear movement guide (12′) and the cutting unit (30) can be formed with the reverse structure.

A pair of alignment units (20, 20′), i.e., left and right alignment sub-units (20, 20′) are provided on both sides of a lower portion of the main body (10). The left alignment sub-unit (20) and the right alignment sub-unit (20′) are spaced apart from each other and move linearly and symmetrically in the left-right direction along the horizontal movement guide (11, 11′) of the main body (10).

The left and the right alignment sub-units (20, 20′) are kind of a linear symmetrical movement grip. In response to the downward movement of the cutting unit (30), the left and the right alignment sub-units (20, 20′) (i) slidingly move in the left-right direction
along the horizontal movement guide (11, 11′) in a symmetrical manner to each other
and (ii) grip both sides of the object (2), respectively, so that the object (2) is aligned between the left and the right alignment units (20, 20′).

For the symmetrical movement of the alignment unit (20, 20′) in the left-right direction, a rear side of the alignment unit (20, 20′) is connected to the horizontal movement guide (11, 11′) of the main body (10) so as to be able to move linearly in the left-right direction.

Specifically, the horizontal movement guides (11, 11′) may include a left and a right horizontal movement guides (11, 11′); and a rear side of the left alignment sub-unit (20) and a rear side of the right alignment sub-unit (20′) are connected to the left and the right horizontal movement guides (11, 11′), respectively.

For example, when the horizontal movement guide (11, 11′) is a horizontal guide rod (11) that extends horizontally at the lower portion of the main body (10), the rear side of the alignment unit (20) may be penetrated by the horizontal movement guide (11). Specifically, the horizontal movement guide (11) may penetrate both the rear side of the left alignment sub-unit (20) and the right alignment sub-unit (20) in the left-right direction. A ball bushing may be provided on each of the rear side of the alignment unit (20).

In another embodiment, the horizontal movement guide (11, 11′) may be a guide rail (11′) provided at the lower portion of the main body (10) and horizontally extending in the left-right direction. In this case, a channel-type slide (LM guide) may be provided on the rear side of the alignment unit (20) so that the channel-type slide (LM guide) can be coupled to the horizontal movement guide, i.e., the guide rail (11′). More specifically, a left channel-type slide (LM guide) is provided on the rear side of the left and the right alignment units (20), and a right channel-type slide (LM guide) is provided on the rear side of the right alignment units (20). The left and the right alignment units (20) and the right alignment units (20) are coupled to the horizontal movement guide, i.e., the guide rail (11′) through the channel-type slide (LM guide).

In addition, to ensure the left-right symmetrical linear movement of the alignment unit (20, 20′), an inclined guide (21) is formed on the front side of the alignment unit (20, 20′). The inclined guide (21) extends upward toward the center of the main body (10). Specifically, to ensure the left-right symmetrical linear movement of the left and the right alignment units (20, 20′), a left and a right inclined guides (21) are formed on the front side of the left alignment sub-unit (20) and on the front side of the right alignment sub-unit (20′), respectively. The left and the right inclined guides (21) extend upward toward the center of the main body (10) in a symmetrical manner to each other.

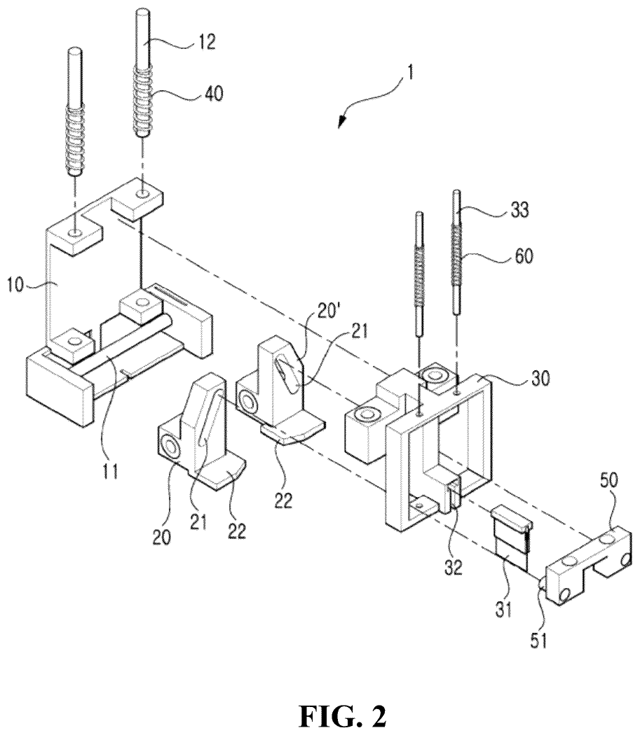

As will described later, an inclined guide corresponding unit (51) of the linkage movement induction unit (50) is coupled to the inclined guide (21) of the alignment unit (20, 20′) in such a manner that the inclined guide corresponding unit (51) can move linearly up and down along the inclined guide (21). Specifically, as shown in FIG. 2, the inclined guide corresponding unit (51) may include left and right inclined guide corresponding units. The left and right inclined guide corresponding units (51) are coupled to the left and the right inclined guides (21), respectively. in such a manner that the left and the right inclined guide corresponding units (51) can move linearly up and down along the left and right inclined guide (21), respectively.

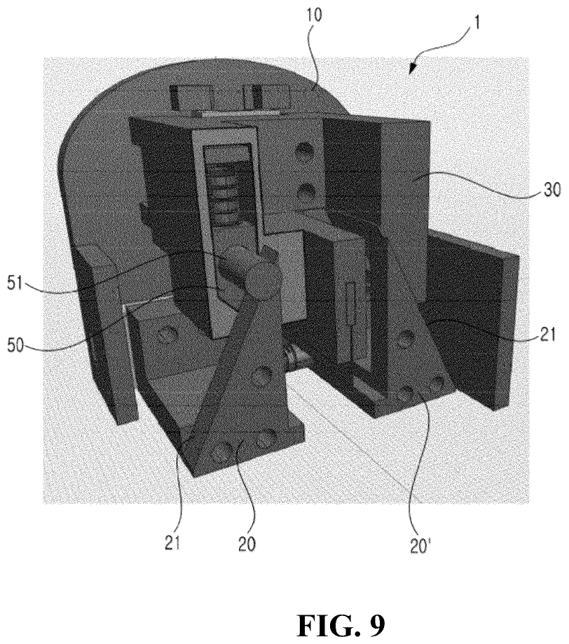

The inclined guide (21) may be (i) an inclined hole as shown in FIGS. 1-4, (ii) an inclined groove as shown in FIGS. 5-8, or (iii) an inclined surface as shown in FIG. 9. Specifically,

The left inclined guide (21) may be (i) an inclined hole as shown in FIGS. 1-4, (ii) an inclined groove as shown in FIGS. 5-8, or (iii) an inclined surface as shown in FIG. 9. Likewise, the right inclined guide (21) may be (i) an inclined hole as shown in FIGS. 1-4, (ii) an inclined groove as shown in FIGS. 5-8, or (iii) an inclined surface as shown in FIG. 9.

In addition, a gripping plate (22) is integrally coupled to the lower front side of the alignment unit (20, 20′). The gripping plate (22) may include a left gripping plate (22) and a right gripping plate (22). Specifically, the left gripping plate (22) extends from a lower front side of the left alignment sub-unit (20) toward the left inclined guide corresponding unit (51). Likewise, the right gripping plate (22) extends from a lower front side of the right alignment sub-unit (20) toward the right inclined guide corresponding unit (51).

When the cutting unit (30) move downwards to press the left and right alignment sub-units (20, 20′), the left and right alignment sub-units (20, 20′) move symmetrically toward the center of the cutting unit (30) to come close to each other. As a result, the gripping plate (22) holds the object (2). Specifically, the left and the right gripping plates (22) come into contact with both sides of the object (2), such as a pill, a sugar cube, solid salt, or a solid detergent, and hold the object (2).

The left and the right gripping plates (22) may be integrally coupled to a lower portion of the left and right alignment sub-units (20, 20′), but may also be replaceably mounted at the lower portion of the left and right alignment sub-units (20, 20′).

The cutting unit (30) is coupled to the upper center of the main body (10) capable of being linearly movable in the up-and-down direction.

The cutting unit (30) is a vertically movable cutter. In response to an external force applied downward, the cutting unit (30) moves downward along the first vertical linear movement guide (12, 12′) of the main body (10). Then, the cutting unit (30) cuts the object (2) aligned by the alignment unit (20, 20′).

To ensure linear movement of the cutting unit (30) in the vertical direction, the rear side of the cutting unit (30) is connected to the first vertical linear movement guide (12, 12′) of the main body (10) so as to be movable linearly in the vertical direction.

In an embodiment, the left and the right first vertical linear movement guides (12, 12′) are respectively a left and a right first vertical guide rods (12). The left and the right first vertical guide rods are coupled to an upper portion of the main body (10) and extend vertically as being spaced apart from each other. The rear side of the cutting unit (30) may be penetrated by the left and the right first vertical linear movement guides (12), i.e., the left and right first vertical guide rods. Additionally, a left and a right first vertical ball bushings, which respectively are formed to correspond to the left and right guide rods, may be provided on the rear side of the cutting unit (30).

In another embodiment, the first vertical linear movement guide (12, 12′) may be a guide rails (12′). The guide rail (12′) is provided at an upper portion of the main body (10) and extends vertically. In this case, a channel-type slide (LM guide) is formed on the rear side of the cutting unit (30) to be corresponding to the first vertical linear movement guide, i.e., guide rail (12′).

A cutting blade (31) for cutting the object (2) is provided at the lower center of the front side of the cutting unit (30).

The cutting blade (31) may be coupled integrally to the lower center of the front side of the cutting unit (30). However, in another embodiment, it is preferable that the cutting blade (31) is in a cartridge form so that the cutting blade (31) can be replaced.

To this end, a cutting blade detachable joint groove (32) for replacing and mounting a cartridge-shaped cutting blade can be formed at the lower center of the front side of the cutting unit (30).

In addition, a second vertical linear movement guide (33) is provided on the front side of the cutting unit (30) to install a linkage movement induction unit (50) and to guide linear movement of the linkage movement induction unit (50) in the up-and-down direction. This structure will be in more detail later.

In an embodiment, the second vertical linear movement guide (33) may include a left and a right second vertical guide rods which are spaced apart from each other on both sides. The cutting unit (30) is in the shape of a square frame when viewed from the front side of the cutting unit (30) for promote installation of the second vertical linear movement guide (33).

It is preferable that both of the left and the right second vertical linear movement guides (33) be coupled to the front portion of the cutting unit (30) as being spaced apart. However, in another embodiment, only one of the left and the right second vertical linear movement guides (33) can be coupled to the front portion of the cutting unit (30).

The cutting unit (30) is coupled to the main body (10) so as to be movable linearly in the up-and-down direction while being elastically biased upward.

To this end, an elastic unit (40) is provided between the main body (10) and the cutting unit (30). The elastic unit (40) elastically biases the cutting unit (30).

For this purpose, the lower portion of the elastic unit (40) is supported on the main body (10) and the upper portion of the elastic unit (40) is supported on the cutting unit (30).

As shown in FIGS. 1-4, the first vertical linear movement guide (12, 12′) is formed of the left and the right first vertical guide rods (12), which are provided on both sides of the upper portion of the main body (10) and extend vertically as being spaced apart from each other. In this case, the elastic unit (40) may be formed of a left and a right first coil springs. The left and the right first coil springs (40) are penetrated by the left and the right first vertical guide rods (12), respectively.

In another embodiment, as shown in FIGS. 5-8, the first vertical linear movement guide (12, 12′) is formed of a guide rail (12′), which is provided on the upper center of the main body (10) and extends vertically. In this case, the elastic unit (40) may be formed of a left and a right second coil springs. The left and the right second coil springs are provided on both sides of the upper portion of the main body (10) and extend vertically as being spaced apart from each other.

A linkage movement induction unit (50) is coupled with the cutting unit (30), particularly with the second vertical linear movement guide (33), so as to be movable linearly in the up and down direction.

When the cutting unit (30) moves. the linkage movement induction unit (50) serves to linearly move the first and the second alignment units (20) closer to the center and thus align the object (2).

As mentioned above, in an embodiment, the second vertical linear movement guide (33) are formed of the left and the right second vertical guide rods. The left and the right second vertical guide rods are coupled to the front portion of the cutting unit (30) and extend vertically as being spaced apart from each other. In this case, the linkage movement induction unit (50) is penetrated by the left and the right second vertical linear movement guides (33). Specifically, the linkage movement induction unit (50) is penetrated by the left and the right second vertical linear movement guides (33).

In addition, an inclined guide corresponding unit (51) is provided at the bottom of the linkage movement induction unit (50) that comes into contact with the inclined guide (21) of the alignment unit (20, 20′). Specifically, the inclined guide corresponding unit (51) includes a left and a right inclined guide corresponding units (51). The inclined guide (21) includes left and right inclined guide (21) which are respectively provided on the left and the right alignment sub-units (20, 20′). The left and the right inclined guide corresponding units (51) come into contact with the left and right inclined guides (21).

In an embodiment, the inclined guide (21) of the alignment unit (20, 20′) is in the form of an inclined hole. In this case, the inclined guide corresponding unit (51) can be formed in the form of a projection that protrudes rearward from the lower portion of the linkage movement induction unit (50) and inserted into the inclined guide (21). Specifically, when each of the left and the right inclined guides (21) is in the form of an inclined hole, each of the left and right inclined guide corresponding units (51) can be formed in the form of a projection that protrudes rearward from the lower portion of the linkage movement induction unit (50) and is insertable into the left and the right inclined guides (21), respectively.

In another embodiment, the inclined guide (21) of the alignment unit (20, 20′) is in the form of a inclined groove which is open backward. In this case, the inclined guide corresponding unit (51) can be formed in the form of a projection that protrudes rearward from the lower portion of the linkage movement induction unit (50) and is insertable into the inclined groove (21). Specifically, when each of the left and the right inclined guides (21) is in the form of a inclined groove, each of the left and right inclined guide corresponding units (51) can be formed in the form of a projection that protrudes rearward from the lower portion of the linkage movement induction unit (50) and is inserted into the left and the right inclined groove (21), respectively.

In another embodiment, as shown in FIG. 9, the inclined guide (21) of the alignment unit (20, 20′) is in the form of a inclined surface. In this case, the inclined guide corresponding unit (51) may be formed as a projection that protrudes forward from the linkage movement induction unit (50) and comes into contact with the inclined surface (21). Although not shown, the linkage movement induction unit (50) may also be formed in the form of an inclined surface that contact the inclined guide (21).

The linkage movement induction unit (50) is connected to the cutting unit (30) in a linearly movable manner in the up-and-down direction as being elastically biased downward.

To this end, an elastic support unit (60) is provided between the cutting unit (30) and the linkage movement induction unit (50) to elastically bias the linkage movement induction unit (50) downward.

For this purpose, the upper portion of the elastic support unit (60) is supported by the cutting unit (30), and the lower portion of the elastic unit (60) is supported by the linkage movement induction unit (50).

In response to alignment the object (2) by the alignment unit (20, 20′) and in response to the entry of cutting blade (31) into the object (2) to cut the object (2) into splitted objects, the elastic support unit (60) allows the split objects to move to opposite sides to each other and allows the alignment unit (20, 20′) to elastically support split objects. The elastic support unit (60) may be a coil spring that is connected to the cutting unit (30) through the second vertical linear movement guide (33). Specifically, the coil spring (60) may include a left and a right coil springs. The second vertical linear movement guide (33) may include a left and a right second vertical linear movement guides (33). The left and the right coil springs are connected to the cutting unit (30) through the left and the right second vertical linear movement guides (33), respectively.

Hereinafter, the alignment and cutting operation of the object (2) using the alignment cutting device (1) according to a preferred embodiment will be described in reference to the attached drawings.

According to a preferred embodiment of the present invention, the alignment cutting device (1) operates as follows. Firstly, when the alignment cutting device (1) is in an unused state: the cutting unit (30) is being lifted upward by the elastic unit (40); the inclined guide corresponding unit (51) of the linkage movement induction unit (50) is positioned above the inclined guide (21) of the alignment unit (20, 20′); and the left and the right alignment sub-units (20, 20′) is spaced apart from each other with a first gap therebetween.

Secondly, the object (2) is inserted between the alignment units (20, 20′). The cutting unit (30) is pressed downward. The left and the right inclined guide corresponding units (51) of the linkage movement induction unit (50) moves vertically along the left and the right inclined guides (21) of the left and the right alignment sub-units (20, 20′), respectively. The left and the right alignment sub-units (20, 20′) move toward the center of the main body (1) in a symmetrical manner to each other, thereby aligning the object (2) to a wanted location, e.g. on the exact center between the left and the right alignment sub-units (20, 20′).

Thirdly, cutting operation is performed as follows. The cutting unit (30) is further pressed downward. The cutting blade (31) of the cutting unit (30) enters into the object (2) to cut the object (2). At the same time, the linkage movement induction unit (50) begins to move upward and elastic force is applied to the left and the right alignment sub-units (20, 20′) so that the left and the alignment sub-units (20, 20′) move farther from each other by a first distance and thus are spaced apart from each other with a second gap therebetween. The second gap is longer than the first gap. The first distance, for example, is a half of the thickness of the cutting blade (31). Under this structure and operation, the object (2) can be clearly cut, rather than being crushed or broken.

As described above, according to the present invention, in response to downward movement of the cutting unit (30), the left and the right alignment sub-units (20, 20′) move closer toward each other in a symmetrical manner. Thereby, the object (2) is aligned between the left and the right alignment sub-units (20, 20′) and cut by the cutting blade (31) of the cutting unit (30). As a result, the object (2), such as a pill, a sugar cube, solid salt, a solid detergent, etc., can be conveniently and accurately cut. According to this structure, the time required for cutting the object (2) can be shortened.

As described above, according to the present invention, when the object (2) is aligned by the alignment unit (20, 20′), both sides of the object (2) are elastically supported by the alignment unit (20, 20′). When the object (2) is cut by the cutting unit (30), a room is provided for the cut or split object (2) to move in opposite directions to each other. Thus, the object (2) can be clearly cut, without being crushed or broken in the course of the cutting process.

Although the preferred embodiments of the present invention have been described with reference to the attached drawings, the embodiments described in this specification and in the drawings are merely one of the embodiments of the present invention and do not represent all of the technical ideas of the present invention. Therefore, it should be understood that various equivalents and modified examples are available.

Therefore, it should be understood that the embodiments described above are illustrative and not restrictive in all respects, and the scope of the present invention is determined by the claims, rather than the detailed description. All changes or modifications derived from the scope of the claims and their equivalents should be construed as being included in the scope of the present invention.

### REFERENCE NUMERALS

1: Alignment cutting device
2: Object
10: Main body
11, 11′: Horizontal movement guide
12, 12′: First vertical linear movement guide
20: Alignment unit
21: Inclined guide
22: Gripping plate
30: Cutting unit
31: Cutting blade
32: Detachable joint groove for cutting blade
33: Second vertical linear movement guide
40: Elastic unit
50: Linkage movement induction unit
51: Inclined guide corresponding unit
60: Elastic support unit

1. An alignment cutting device, comprising:
a main body;
an alignment unit which is movably coupled to the main body and grips an object from both sides of the object and aligns the object;
a cutting unit which is movably coupled to the main body and having a cutting blade for cutting the object;
a linkage movement induction unit which moves the alignment unit in response to movement of the cutting unit to align the object below the cutting blade;
an inclined guide coupled to the alignment unit; and
an inclined guide corresponding unit coupled to the linkage movement induction unit,
wherein the inclined guide corresponding unit is connectable to the inclined guide.

2. The alignment cutting device of claim 1, further comprising:
an elastic support unit,
wherein the alignment unit includes a left and a right the alignment sub-units,
wherein, when the object is aligned by the alignment unit, the elastic support unit (i) elastically supports the left and the right alignment sub-units and (ii) moves the left and right alignment sub-units to get farther from each other.

3. The alignment cutting device of claim 1, further comprising:
a horizontal movement guide coupled to a lower portion of the main body,
wherein the alignment unit includes a left and a right alignment sub-units facing to each other,
wherein the left and the right alignment sub-units are coupled to a front of the main body and arranged in a side by side manner with each other,
wherein each of the left and the right alignment sub-units is coupled with the horizontal movement guide to be linearly movable along the horizontal movement guide.

4. The alignment cutting device of claim 1,
wherein a first vertical movement guide is coupled with the main body,
wherein the cutting unit is coupled with the first vertical movement guide to be linearly movable along the first vertical movement guide.

5. The alignment cutting device of claim 1,
wherein the cutting blade is replaceably connected to the cutting unit.

6. The alignment cutting device of claim 1,
wherein the inclined guide is an inclined hole or a inclined groove,
wherein the inclined guide corresponding unit is a protrusion which is insertable into the inclined guide.

7. The alignment cutting device of claim 1,
wherein the inclined guide is a first inclined surface,
wherein the inclined guide corresponding unit is a protrusion or a second inclined surface which is connectable with the first inclined surface.

8. The alignment cutting device of claim 2,
wherein the linkage movement induction unit is coupled to the cutting unit to be movable linearly in a vertical direction,
wherein the elastic support unit is provided between the cutting unit and the linkage movement induction unit.

9. An alignment cutting device, comprising:
a main body;
a horizontal movement guide coupled to a lower portion of the main body;
a first vertical linear movement guide coupled to an upper portion of the main body;
an alignment unit coupled to the lower portion of the main body, wherein the alignment unit includes a left and a right alignment sub-units arranged in a symmetrical manner to each other, wherein a rear side of the alignment unit is connected to the horizontal movement guide of the main body in a horizontally movable manner along the horizontal movement guide;
a left and a right inclined guides respectively provided on a front side of the left alignment sub-unit and on a front side of the right alignment sub-unit, wherein each of the left and the right inclined guides extends upwardly and inclinedly toward a center of the main body;
a cutting unit coupled to an upper center of the main body, wherein a rear side of the cutting unit is connected to the first vertical linear movement guide in a vertically movable manner;
a second vertical linear movement guide connected to a front side of the cutting unit;
a cutting blade for cutting an object, wherein the cutting blade is coupled to a lower center of the cutting unit;
an elastic unit provided between the main body and the cutting unit and elastically biases the cutting unit upward;
a linkage movement induction unit connected to the second vertical linear movement guide of the cutting unit in a linearly movable manner in a vertical direction;
an inclined guide corresponding unit, wherein the inclined guide corresponding unit includes a left and a right inclined guide corresponding units connected to a lower portion of the linkage movement induction unit, wherein the left and the right inclined guide corresponding units respectively are coupled to the left and the right inclined guides, wherein the linkage movement induction unit moves the left and the right alignment sub-units to get closer to each other in a symmetrical manner to each other and aligns the object when the cutting unit moves downward; and
an elastic support unit provided between the cutting unit and the linkage movement induction unit, wherein the elastic support unit elastically biases the linkage movement induction unit downward to make the object elastically supported by the alignment unit.

10. The alignment cutting device of claim 9,
wherein the horizontal movement guide is a horizontal guide rod which provided in the lower portion of the main body and extends horizontally,
wherein the rear side of the alignment unit is penetratedly coupled to the horizontal movement guide.

11. The alignment cutting device of claim 9,
wherein the horizontal movement guide is provided in the lower portion of the main body and extends horizontally,
wherein a channel-type slide is provided on the rear side of the alignment unit and is movably coupled to the horizontal movement guide.

12. The alignment cutting device of claim 9,
wherein the first vertical linear movement guide includes a left and a right first vertical guide rods,
wherein the left and the right first vertical guide rods are coupled to the upper portion of the main body and extend vertically as being spaced apart from each other, wherein the rear side of the cutting unit is penetrated by the first vertical linear movement guide,
wherein the elastic unit is a coil spring, wherein the coil spring surrounding surrounds the first vertical linear movement guide.

13. The alignment cutting device of claim 9,
wherein the first vertical linear movement guide is a guide rail, wherein the guide rail is provided in the upper center of the main body and extends vertically,
wherein a channel-shaped slide is coupled to the rear side of the cutting unit,
wherein the channel-shaped slide is coupled to the first vertical linear movement guide in a movable manner,
wherein the elastic unit includes a left and a right coil springs,
wherein the left and the right coil springs are provided through a top of the main body and extend vertically as being spaced apart from each other.

14. The alignment cutting device of claim 9,
wherein a left and a right gripping plates are integrally coupled to or replaceably coupled to a lower front side of the left alignment sub-unit and a lower front side of the right alignment sub-unit, respectively.

15. The alignment cutting device of claim 9,
wherein the cutting blade is replaceably connected to a lower center portion of the front side of the cutting unit.

16. The alignment cutting device of claim 9,
wherein the second vertical linear movement guide includes a left and a right second vertical guide rods,
wherein the left and the right second vertical guide rods are coupled to a front side of the main body and extend vertically as being spaced apart from each other,
wherein the linkage movement induction unit is penetratingly connected to the second vertical linear movement guide,
wherein the elastic support unit is a coil spring penetratingly connected to the second vertical linear movement guide.

17. The alignment cutting device of claim 9,
wherein each of the left and the right inclined guides is an inclined hole or an inclined groove,
wherein each of the left and the right inclined guide corresponding units is a protrusion insertable into the left and the right inclined guides, respectively.

18. The alignment cutting device of claim 9,
wherein each of the left and the right inclined guides is a first inclined surface,
wherein each of the left and the right inclined guide corresponding units is a protrusion or a second inclined surface connectable to the first inclined guide.
